(19) United States
(12) Patent Application Publication
(10) Pub. No.: US 2017/0353722 A1
(43) Pub. Date: Dec. 7, 2017

(54) A METHOD FOR ENCODING A DIGITAL IMAGE, DECODING METHOD, DEVICES, AND ASSOCIATED COMPUTER PROGRAMS

(71) Applicants: B<>COM, Cesson Sevigne (FR); Orange, Paris (FR)

(72) Inventor: Joel Jung, Le Mesnil Saint Denis (FR)

(21) Appl. No.: 15/538,970

(22) PCT Filed: Dec. 14, 2015
(86) PCT No.: PCT/FR2015/053471

§ 371 Date: Jun. 22, 2017

(30) Foreign Application Priority Data
Dec. 22, 2014 (FR) 1463137

(51) Int. Cl. H04N 19/119; H04N 19/139; H04N 19/147; H04N 19/176

(52) U.S. Cl. CPC H04N 19/119; H04N 19/176; H04N 19/139; H04N 19/147

(57) ABSTRACT

A method for encoding a digital image, which is divided into a plurality of blocks of pixels processed in a defined order. The method includes the following acts for a current block: a) obtaining a basic motion vector of the current block with respect to a reference image previously decoded; b) obtaining a partitioning into sub-blocks of the area pointed to in the reference image by the basic motion vector and applying the partitioning obtained to the current block; and c) scanning the sub-blocks of the current block according to a predetermined scanning order and encoding the sub-blocks scanned. The encoding includes modifying the partitioning of the current block into sub-blocks according to predetermined rules, coding the sub-blocks of the modified partitioning comprising coding reporting information on the modification of the partitioning, and validating the modified partitioning by applying a rate-distortion criterion to the coded sub-blocks of the modified partitioning.

### 1. CROSS-REFERENCE TO RELATED APPLICATIONS

This application is a Section 371 National Stage application of International Application No. PCT/FR2015/053471, filed Dec. 14, 2015, the content of which is incorporated herein by reference in its entirety, and published as WO 2016/102804 on Jun. 30, 2016, not in English.

### 2. FIELD OF THE INVENTION

The field of the invention is that of signal compression, in particular of a digital image or of a sequence of digital images, divided into blocks of pixels.

The encoding/decoding of digital images applies in particular to images coming from at least one video sequence comprising:
images coming from the same camera and succeeding each other temporally (type-2D encoding/decoding),
images from different cameras oriented according to different views (3D-type encoding/decoding),
components of corresponding texture and depth (3D-type encoding/decoding),
etc.

The present invention applies in a similar manner to the 2D- or 3D-type encoding/decoding of images.

The invention may especially, but not exclusively, apply to the video encoding implemented in the current AVC and HEVC video encoders and their extensions (MVC, 3D-AVC, MV-HEVC, 3D-HEVC, etc.) and to corresponding decoding.

The invention can also be applied to audio encoding, for example implemented in current audio encoders (EVS, OPUS, MPEG-H, etc.) and their extensions and to the corresponding decoding.

### 3. PRESENTATION OF THE PRIOR ART

A conventional compression scheme of a digital image is considered, in which the image is divided into blocks of pixels. A current block to be encoded, which constitutes an initial coding unit, is generally cut into a variable number of sub-blocks according to a predetermined cutting mode. Standard encoders offer regular partitioning, which relies on square or rectangular blocks of fixed size. Partitioning is always done from the initial unpartitioned coding unit, and the final partitioning is calculated and then reported from this neutral basis. In connection with FIG. 1a, we present an example of block partitioning with size 16×16, 8×8 or 4×4 authorised by the standard. In connection with FIG. 1b, there is illustrated an example of partitioning permitted by the HEVC standard. This standard is specified in the document “ISO/IEC 23008-2:2013—High efficiency coding and media delivery in heterogeneous environments—Part 2: High efficiency video coding>>, International Organization for Standardization, published in November 2013. We see that we are dealing with QuadTree partitioning, which remains regular, but is more flexible than the AVC standard, from 64×64 size blocks.

The partitioning according to the HEVC standard has the advantage of adapting the coding to the structure of the image, in particular to the presence of zones with homogeneous and inhomogeneous texture. For example, FIG. 2a offers a 64×64 block having a homogeneous zone and two detail zones. FIG. 2b shows a possible partitioning of HEVC to code the block of FIG. 3.

A disadvantage of this partitioning is that it is not yet flexible enough to allow to stick to the variations in texture of the image, while it already generates a reporting that is not negligible in terms of coding cost. For example, to encode the final partitioning of FIG. 4, we see that 28 motion vectors should be transmitted and that the reporting of the final partitioning could be: 1 0 1 100001000000 1 00010000 1 001000010000.

There is known from the patent application published under the number WO2011/127966, a method for encoding a 3D digital image, in planes, according to which the partitioning implemented for the coding of a plane of this image, for example the texture plane, is inherited during the coding of the associated depth plane. This results in a substantial saving in terms of reporting.

It is known from the patent application published under number WO2008/150113 that the current block of an image to be coded is inherited from the partitioning of the area pointed to by its motion vector in a reference image.

A shortcoming of this prior art is that the partitioning proposed by the prior art remains too constrained and still does not make it possible to adapt finely to the shapes and the textures of the objects contained in the image to be coded.

### 4. SUMMARY OF THE INVENTION

An aspect of the present disclosure relates to an encoding method of a digital image, said image (Im) being divided into a plurality of blocks of pixels processed in a defined order, characterised in that said method comprises the following steps, implemented for a current block (b):
a) Obtaining a motion vector, said basic motion vector of the current block with respect to a previously decoded reference image;
b) Obtaining a partitioning into sub-blocks of area pointed to in the reference image by the basic motion vector and applying the partitioning obtained to the current block (b);
c) Scanning the sub-blocks of the current block according to a predetermined scanning order and then encoding of the scanned sub-blocks, said encoding comprising a step of modifying the partitioning of the current block into sub-blocks according to predetermined rules, a step of coding the sub-blocks of the modified partitioning comprising the coding of reporting information on the modification of the partitioning and a step of validating the modified partitioning by applying a rate-distortion criterion to the coded sub-blocks of the modified partitioning.

Thus, the invention relies on an entirely novel and inventive approach to image encoding, which consists in applying to the current block the partitioning of the zone of the same size of the reference image pointed to by the basic motion vector obtained for the current block.

In contrast to the prior art, which in one case calculates and marks a new complete partitioning per current block and in the other case makes it inherit the current block of a plane of the image to be coded from the partitioning used for the co-located block from another plane of the image to be coded, for example the depth plane, the invention takes advantage of the textural similarities which exist between the current block of the current image and the zone pointed to in the reference image, to optimize the partitioning of the current block.

As a result, the initial partitioning structure of the current block need not to be transmitted to the decoder as reporting information in the data stream since it can be obtained from the reference image previously processed.

It also follows that the partitioning structure is irregular: unlike the standard coders which apply regular partitioning, for example of the “quadtree” type, the partitioning proposed by the invention is not regular and, although complex, remains simple to signal, because it is partly inherited from the reference image.

The invention therefore makes it possible to better adapt the partitioning of a block to the content to be coded, while optimising the coding cost.

The invention thus proposes a novel encoding mode for a current block, which can advantageously be put in competition with other known encoding modes of the currently standardised encoding schemes, such as, for example, the Intra, Inter or Merge modes of the HEVC standard.

The partitioning obtained from the reference image constitutes an initial partitioning of the current block, which the invention proposes to modify in order to adapt more finely to the specific texture of the current block. This modification can consist of a merger of neighbouring partitions or a splitting of a partition.

Advantageously, this modification is validated by comparison with the initial partitioning. Once validated, the modification is marked in the bit stream, for example by difference with the initial partitioning. The marking of the partitioning changes allows small additional coding overhead associated with it.

According to an advantageous characteristic of the invention, the step of obtaining the basic motion vector comprises estimating the movement of the current block with respect to the reference image previously decoded according to an error minimisation criterion.

Advantageously, the invention implements a particular motion estimation of the current block with respect to a reference image. It provides the basic motion vector used to obtain the initial partitioning of the current block from the reference image. It favours an error minimisation criterion rather than a block coding cost criterion so as to ensure that the content of the area pointed to by the estimated basic motion vector is as similar as possible to that of the current block.

According to an advantageous characteristic of the invention, the modification comprises merging a sub-block of the coded current partitioning with at least one already coded neighbouring sub-block.

A modification proposed by the invention is to merge two or more neighbouring sub-blocks of the current block to code them as a single partition. The modification of the partitioning is indicated in the bitstream. Due to the inheritance of the initial partitioning, marking does not constitute an important overhead, especially since a basic motion vector can be saved as a result of this merging. The invention makes it possible to make a compromise between the additional cost linked to the modification of the partitioning and the reduction of the cost associated with the marking of the motion vector.

Indeed, it is possible either to make a motion estimation specific to the sub-block resulting from the merging, so as to guarantee a more efficient coding of the merged sub-block, or to reuse the basic motion vector implemented for at least one of the merged sub-blocks, so as to minimise the additional marking. For example, we can take the mean of the motion vectors of the merged blocks, or the minimum of the two, or that which corresponds to the largest initial sub-block, etc.

According to another aspect of the invention, the modification of the current partitioning further comprises splitting at least one sub-block into at least two sub-blocks.

It is also possible to further break down a sub-block of the initial partitioning. The partitionings obtained are coded individually. The modification of the partitioning is marked in the bitstream, as well as any possible basic motion vectors.

Advantageously, the step of splitting said at least one sub-block into at least two sub-blocks, so-called sub-blocks broken down, comprises the implementation of steps a) and b) for obtaining a basic motion vector and applying the partitioning of the area pointed to by the basic motion vector for said at least one current sub-block.

The principle of defining an initial partitioning of the current block from that of the block pointed to by the motion vector estimated in the reference image is here applied recursively for the sub-blocks broken down. The advantage is to adapt as finely as possible the partitioning, thus the prediction and the coding to the structure of the image.

The method which has just been described in its various embodiments is advantageously implemented by a device for encoding a digital image according to the invention.

Such a device for encoding a digital image is particular in that it is capable of implementing the following units, implemented for a current block:
Obtaining a motion vector, said vector basic motion of the current block with respect to a previously decoded reference image;
Obtaining a partitioning into sub-blocks of the area pointed in the reference image by the basic motion vector and applying the partitioning obtained at the current block;
Scanning through the sub-blocks of the current block according to a predetermined scanning order and then encoding of the scanned sub-blocks, said encoding comprising a step of modifying the partitioning of the current block into sub-blocks according to predetermined rules, encoding the sub-blocks of the modified partitioning comprising the coding of reporting information on the modification of the partitioning and validating the modified partitioning by applying a rate-distortion criterion to the coded sub-blocks of the modified partitioning.

Correlatively, the invention also relates to a method for decoding a digital image from a bitstream comprising coded data representative of said image, said image being divided into a plurality of blocks of pixels processed in a defined order, said method comprising the following steps, implemented for a block, so-called current block:
a′) Obtaining a basic motion vector of the current block and a previously decoded reference image, said motion vector pointing to an area of the reference image, of the same size as that of the current block;
b′) Obtaining a partitioning into sub-blocks of the area pointed in the reference image by the basic motion vector and applying the partitioning obtained at the current block;
c′) Scanning through the sub-blocks of the current block according to a predetermined scanning order and then decoding the coded data read in the bitstream for the scanned sub-blocks, said decoding comprising a modification of the initial partitioning, obtaining for the current block according to coded data representative of a reporting of the modification of the partitioning and the decoding of the modified partitioning.

Thus, the decoding method reproduces the principle of application to the current block the partitioning of an area of the same size pointed to by the motion vector of the current block in a reference image, proposed by the invention.

Advantageously, the implementation of this coding mode specific to the invention for the current block is signalled to it in the bitstream, which also comprises a field representative of the basic motion vector to be used. This basic motion vector may have been estimated specifically to code the current block according to the invention and in this case the field in question codes its components. According to a variation, it corresponds to an estimated motion vector for a neighbouring block and the field comprises an index representative of the neighbouring block.

The initial partitioning is advantageously modified according to the reporting data read in the bitstream.

According to an advantageous characteristic of the invention, when the coded data signal a merge, the step of modifying the initial partitioning replaces said at least two neighbouring sub-blocks of the initial partitioning by a sub-block in the modified partitioning and the step of decoding comprises decoding the sub-block.

When the modification is a merger of at least two neighbouring sub-blocks, the reporting of this merger in the bitstream enables the decoder to update the initial partitioning.

According to an advantageous characteristic of the invention, when the coded data signal a split of a sub-block of the current partitioning into at least two sub-blocks, the step of modifying the partitioning applies the split signalled to the current sub-block and the step of decoding indeed decodes the obtained sub-blocks in a predetermined scanning order.

When the modification is a split, the reporting of the splitting in the bitstream allows the decoder to update the initial partitioning.

According to one aspect of the invention, the signalled split is a regular split, for example of the “quadtree” type.

According to an advantageous variation, the reporting data indicate to the decoder that the coding mode chosen for the current sub-block is the coding mode according to the invention, that is to say by applying the partitioning of a zone of the reference image pointed to by a basic motion vector. The decoder then implements the steps a′), b′) and c′) for the current sub-block, which leads to an irregular split of this sub-block.

The decoding method which has just been described is advantageously implemented by a device for decoding a digital image, said device for decoding a digital image from a bitstream comprising coded data representative of said image, said image being divided into a plurality of blocks processed in a defined order, is particular in that it comprises the following units, capable of being implemented for a block, so-called current block:
Obtaining a basic motion vector of the current block and a previously decoded reference image, said motion vector pointing to an area of the reference image, of the same size as that of the current block;
Application to the current block the partitioning into sub-blocks of the area pointed to in the reference image by the basic motion vector;
Scanning through the sub-blocks of the current block according to a predetermined scanning order and then decoding the coded data read in the bitstream for the scanned sub-blocks, said decoding comprising a modification of the initial partitioning, obtaining for the current block according to coded data representative of a reporting of the modification of the partitioning and the decoding of the modified partitioning.

Correlatively, the invention relates to a signal carrying a bitstream comprising coded data representative of a digital image, said digital image being divided into blocks of pixels processed in a defined order. The signal according to the invention is particular in that, for a current block, said coded data comprise a field representative of a basic motion vector of the current block with respect to a reference image, a field representative of a coding mode by applying the partitioning of the area of the same size as the current block, pointed to by the basic motion vector in the reference image, so-called initial partitioning, and coded data representative of a marking of the modification of the initial partitioning.

Correlatively, the invention relates to a user terminal. Such a terminal is particular in that it comprises a device for coding a digital image and a device for decoding a digital image according to the invention.

The invention also relates to a computer program comprising instructions for implementing the steps of a method for encoding a digital image as described above, when this program is executed by a processor.

The invention also relates to a computer program comprising instructions for implementing the steps of a method for decoding a digital image as described above, when this program is executed by a processor.

These programs can use any programming language. They can be downloaded from a communication network and/or recorded on a computer-readable medium.

Finally, the invention relates to recording media, readable by a processor, integrated or not integrated with the device for encoding a digital image and with the device for decoding a digital image according to the invention, optionally removable, storing respectively a computer program implementing a coding method and a computer program implementing a decoding method, as described above.

### 5. LIST OF FIGURES

Other features and advantages of the invention will become evident on reading the following description of one particular embodiment of the invention, given by way of illustrative and non-limiting example only, and with the appended drawings among which:

FIGS. 1a and 1b, already described, illustrate examples of block partitioning respectively authorised and prohibited by the AVC standard;

FIGS. 2a and 2b, already described, illustrate examples of block partitioning respectively authorised and prohibited by the HEVC standard;

FIGS. 3a, 3b, 3c and 3d, already described, respectively show an example of block texture having a homogeneous area and detail areas as well as block partitioning steps according to the HEVC standard;

FIG. 4 shows schematically the steps of a method of encoding a digital image according to the prior art;

FIG. 5 schematically shows the steps of a method of encoding a digital image according to a first embodiment of the invention;

FIG. 6 schematically shows the steps of a method of decoding a digital image according to a second embodiment of the invention; and

FIG. 7 details a first modification example of the partitioning of the current block by splitting a sub-block of the partitioning of the current block;

FIG. 8 details a second example of coding a current block implementing a modification of the partitioning of the block by splitting a sub-block of the partitioning of the current block;

FIG. 9 details a third example of coding a current block implementing a modification of the partitioning of the block by merging a sub-block with a neighbouring sub-block of the partitioning;

FIGS. 10a and 10b show an example of merging two sub-blocks of an initial partitioning according to one embodiment of the invention;

FIGS. 11a to 11e show an example of coding a current block according to an embodiment of the invention, when several successive operations of merging and splitting of the partitioning are implemented;

FIG. 12 schematically shows the steps of a method of decoding a digital image from coded data according to an embodiment of the invention;

FIG. 13 shows schematically an example of a hardware structure of an encoding device according to an embodiment of the invention; and

FIG. 14 shows schematically an example of a hardware structure of a decoding device according to an embodiment of the invention.

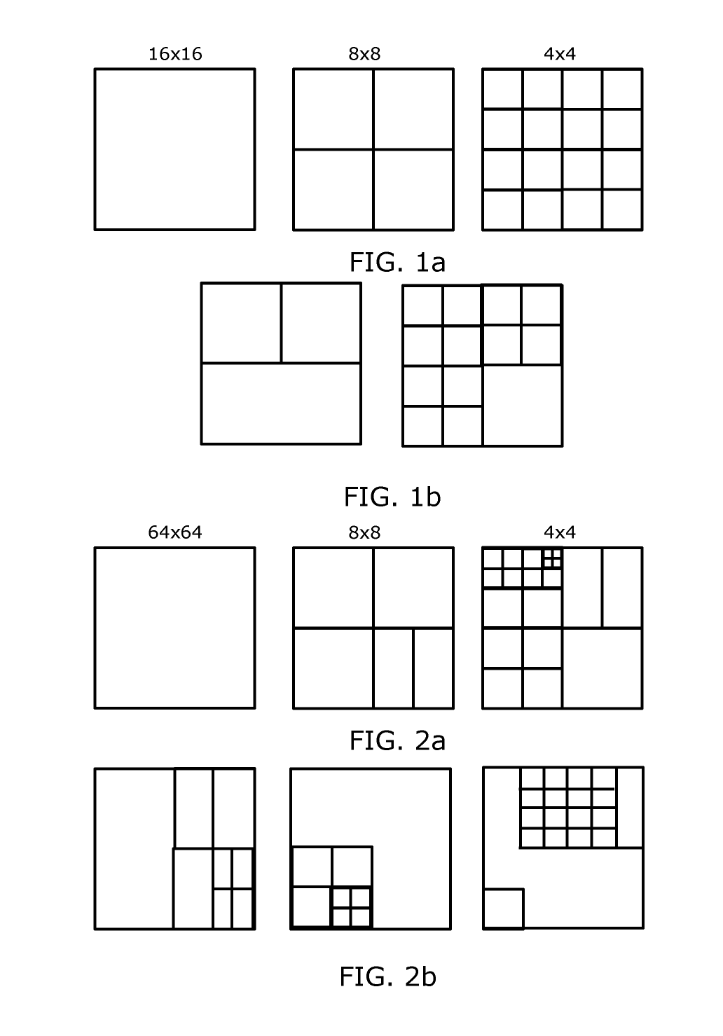

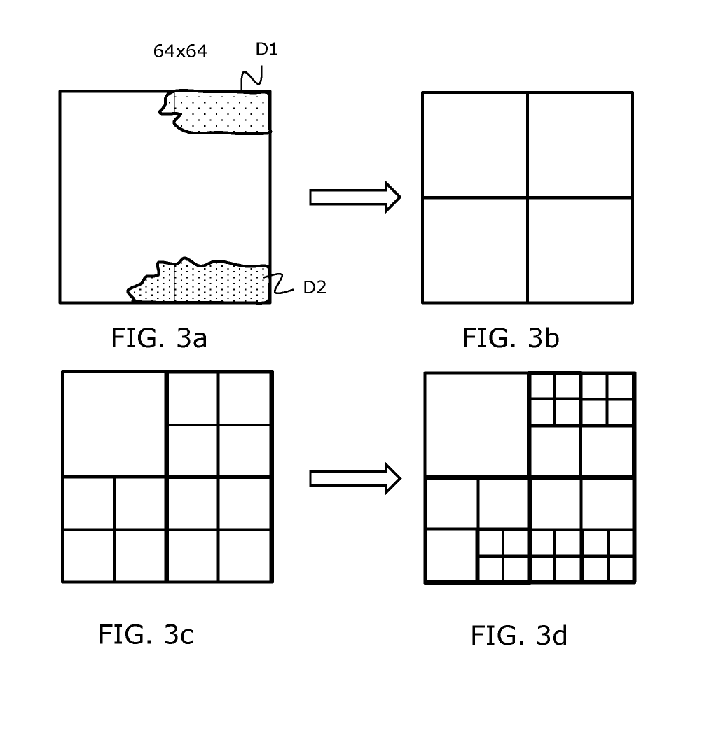

### 6. DESCRIPTION OF A PARTICULAR EMBODIMENT OF THE INVENTION

The general principle of the invention is based on the application to the current block the partitioning of the zone pointed to by the basic motion vector resulting from the motion estimation between the current image and a reference image.

We consider an original video consisting of a sequence of M images I1, I2, . . . IM, with M a non-zero integer. The images are encoded by an encoder, the coded data are inserted a TB bitstream transmitted to a decoder via a communication network, or a compressed file FC, for storage on a hard drive for example. The decoder extracts the encoded data, which are then received and decoded by a decoder in a predefined order known to the coder and the decoder, for example in the temporal order I1, then I2, . . . , then IM, whereas this order may differ according to the embodiment.

Furthermore, the decoded current image is denoted ID. It will be noted that, in a video coder, the image ID is (re)constructed in the encoder so as to be used to predict the other pixels of the video.

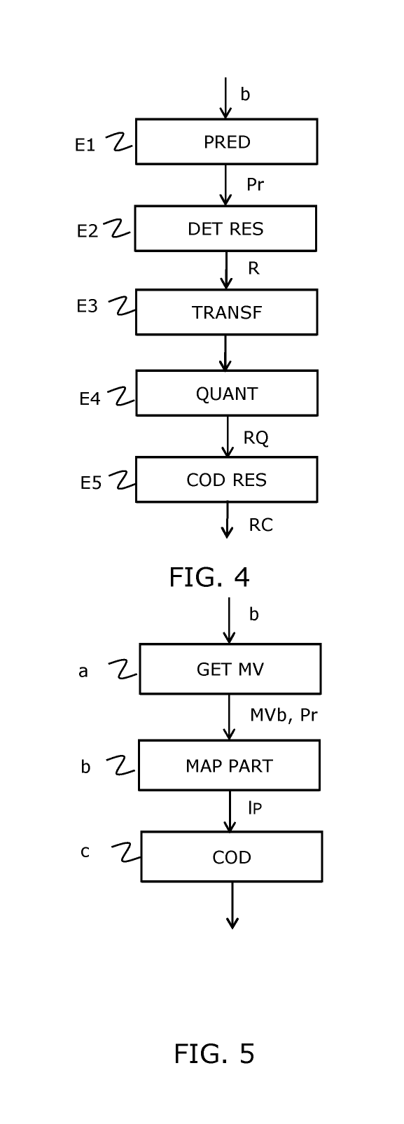

When encoding an image Im, where m is an integer between 1 and M, said image is subdivided into blocks of predetermined maximum size, for example 64×64, called CTU (for “Coding Tree Unit”) according to the HEVC standard, which in turn can be subdivided into smaller blocks, the coded block being called CU (for “Coding Unit”). Each CU will undergo a coding or decoding operation consisting of a sequence of operations, including but not limited to prediction, residual computation, transformation, quantisation and entropy coding. This sequence of operations is presented in conjunction with FIG. 4.

The first block CTU to be processed is selected as the current block b. For example, this is the first block (in lexicographic order). This block comprises N×N pixels.

It is assumed that there are L possible partitionings into blocks CU numbered from 1 to L, and that the partitioning used on block C corresponds to the partitioning number 1. For example, there can be 4 possible partitionings, into sub-blocks of size 4×4, 8×8, 16×16 and 32×32 according to a regular mode of “quad tree” splitting.

During a step E1, a prediction Pr of the original block b is determined. It is a prediction block constructed by known means, typically by motion compensation (block originating from a previously decoded reference image), or by MERGE prediction (block reconstructed from a block originating from a previously decoded reference image pointed to by a vector derived from the neighbouring blocks of the current block), or by intra prediction (block constructed from the decoded pixels immediately adjacent to the current block in the image ID). The prediction information related to P is encoded in the bitstream TB or compressed file FC. We assume here that there are K possible prediction modes m1, m2, . . . , mK, with K a non-zero integer. For example, the prediction mode chosen for the current block b is the mode mk. Some prediction modes are associated with an Intra-type prediction, others with an INTER-type prediction, others with a MERGE-type prediction.

During a step E2, an original residue R is formed by subtraction R=b-Pr from the prediction Pr of the current block b to the current block b.

During a step E3, the residue R is transformed into a transformed residue block, called RT, by a transform of the DCT type or transformed into wavelets, both known to those skilled in the art and in particular implemented in the JPEG standards for DCT and JPEG2000 for the wavelet transform.

At E4, the transformed residue RT is quantised by conventional quantification means, for example scalar or vector, into a quantified residue block RQ. This quantised block RQ contains N×N coefficients. In a manner known in the state of the art, these coefficients are scanned in a predetermined order so as to constitute a one-dimensional vector RQ [i], where the index i varies from 0 to N²−1. The index i is called the frequency of the coefficient RQ [i]. Conventionally, these coefficients are scanned in ascending order of frequency, for example according to a zigzag path, which is known from the JPEG fixed image encoding standard.

During a step E5, the amplitude information of the coefficients of the residual block RQ is coded by entropy coding, for example according to a Huffman coding technique or arithmetic coding technique. By amplitude is meant here the absolute value of the coefficient. Conventionally, it is possible to code for each coefficient a piece of information representative of the fact that the coefficient is non-zero. Then, for each non-zero coefficient, one or more pieces of information relating to the amplitude are coded. The coded amplitudes CA are obtained. In general, the signs of the coefficients are simply coded by a bit 0 or 1.

The preceding steps E1 to E5 are repeated for the possible l partitionings of the current block b. For a partitioning l, each of the sub-blocks CU of the current block b are processed as described above, a type of prediction (Inter or Intra) being authorised per CU. In other words, the sub-blocks of a sub-block CU are all subjected to the same type of prediction.

For example, the coded data for each of the l possible partitionings are put in competition according to a rate-distortion criterion and the partitioning which obtains the best result according to this criterion is finally retained.

The other blocks of the image I1 are processed in the same way, and the same goes for the following images of the sequence.

FIG. 5 now shows the steps of the method of encoding according to a first embodiment of the invention.

At input, one considers in particular a current block b, of the CU type of a following image, for example Ii with i an integer greater than or equal to 2. We place ourselves in an Inter type prediction mode in which a block of Prediction Pr is obtained by motion compensation with respect to a reference image IR previously coded and then decoded.

The current block b will be coded according to a particular INTER prediction mode, specific to the invention. Of course this mode can be put in competition with other INTER or INTRA prediction modes known to those skilled in the art and specified by a coding standard such as HEVC or a future standard.

It will be noted that at least the first image of the sequence of images to be coded has been coded in a conventional manner.

In a step a) of estimating the motion of the current block b with respect to the reference image IR, a basic motion vector MVb is determined, which points to an area of the reference image, of the size of the current block b, also called the prediction block Pr. Note that this area does not necessarily correspond to a block previously coded in the reference image, but it can straddle several blocks of this image. In other words, the prediction block Pr can be seen as a composition of adjacent pieces of the blocks of the reference image that it covers.

Note that according to the invention, the initial motion estimation phase only takes into account the pixel to pixel distortion, and in no case concepts such as the cost of coding, as is usually done, for example, with HEVC-type coding. Indeed, the objective of this motion estimation is to find the best prediction area in the sense of pixel to pixel distortion, in order to implement the partitioning of this area to the current block. The coding cost is taken into account later in the competition between the different prediction modes, particularly that of the invention and those specified for instance by a HEVC-type standard.

During a step b), one obtains the partitioning of the prediction block Pr in the image IR. The partitioning of the blocks of the reference image IR have been for this purpose stored in a memory and the partitioning of the prediction block Pr is reconstructed from the partitioning information stored to the blocks of the image IR which have been at least partially covered by the prediction block Pr. We understand that the partitioning l_{P} obtained does not necessarily satisfy the partitioning rules generally imposed by the specifications of a standard such as HEVC. In particular, it is not necessarily regular. An example of irregular partitioning achieved by the invention is illustrated in FIG. 10a.

The partitioning lP obtained is then applied to the current block b.

In a step c), the sub-blocks from the partitioning lP applied to the current block b are scanned in a predetermined order and treated as previously described in connection with FIG. 4. For a sub-block of b, a prediction Pr is obtained, a residue R is calculated from this prediction Pr, then the residue is transformed, quantised and finally coded (RC).

It will be appreciated that various orders of scanning of the sub-blocks of a partitioning are possible, including:
from left to right, in a zig-zag manner;
by order of increasing or decreasing size;

Two different scanning orders lead to different partitionings. Several scanning orders may compete. In this case, the scanning order selected will be marked in the bitstream.

In one aspect of the invention, the initial motion vector MVb is transmitted in the bitstream.

Alternatively, it is not transmitted, but it is derived from its neighbours:
Reproducibly to the decoder; or
By an index marking a choice among competing candidates.

In this first embodiment of the invention, the partitioning applied to the current block does not need to be marked because it can be inferred from the reference image prediction block.

Advantageously, the coded data obtained are put in competition with those from a conventional coding scheme, such as the HEVC standard. A rate-distortion criterion is taken into account to compare the different coding modes.

The coded data derived from the partitioning which won the competition are inserted into the bit stream TB or a file FC.

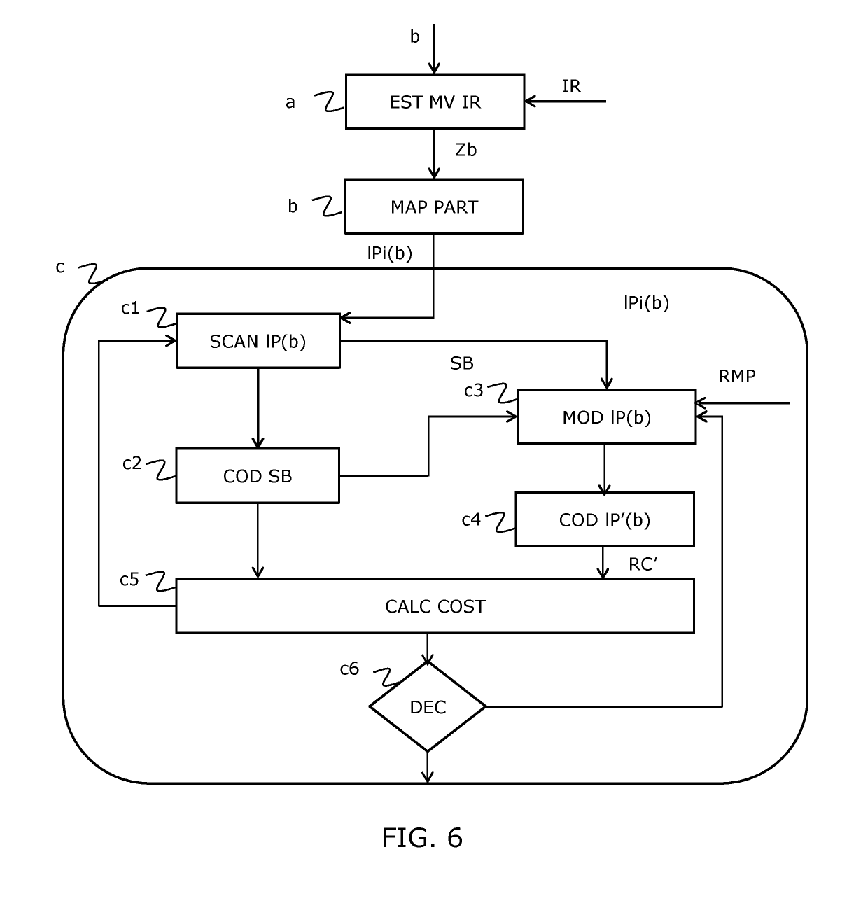

In relation to FIG. 6, we now describes the step c) of sub-block coding of the current block b according to the partitioning lP according to a second embodiment of the invention.

The sub-blocks SB of the current block b are scanned in c1, in a predetermined scanning order.

Two cases are possible:
In the first case, already described in connection with FIG. 5, the sub-block SB is processed conventionally in c2;
In the second case, the sub-block is submitted in c3 to a change in partitioning. This modification can be either a splitting of the sub-block into sub-blocks of smaller sizes or a merger of the sub-block with a neighbouring sub-block already processed.

The new sub-block(s) obtained are then coded in c4.

In this second embodiment of the invention, the modifications in the initial partitioning lPi applied to the current block b shall be indicated in the bit stream TB since they cannot be deduced from those of the prediction block of the reference image. Advantageously, they are indicated in difference with respect to the initial partitioning. We understand that a possible signal could indicate the first type of modification applied, splitting or merging, and the differences with the initial partitioning.

In c5, the coded data obtained in the first and second cases are put in competition and evaluated according to a rate-distortion criterion. The partitioning with the best performance according to this criterion is adopted.

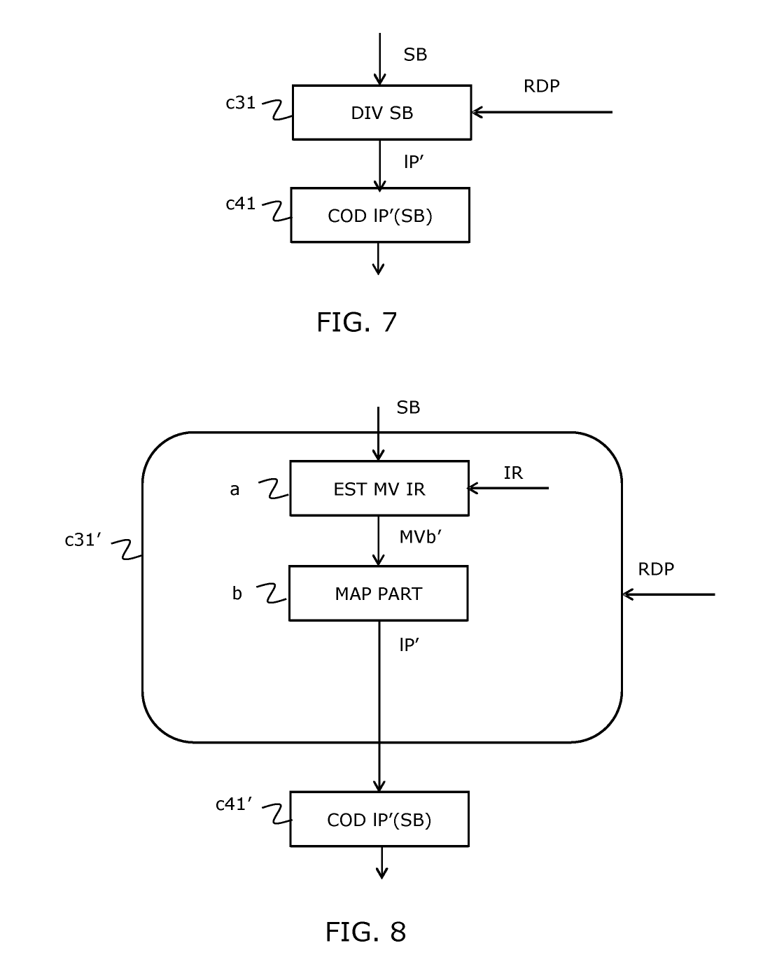

In relation to FIG. 7, we now describe the sub-steps of modification by splitting and coding the partitioning of the current sub-block SB according to a first embodiment of the invention. For example, the splitting is made in c31 according to the specifications of the HEVC standard, according to a “quadtree” mode. A partitioning lP(SB) is obtained and its sub-blocks are coded in d41 as previously described.

In a second example of splitting a sub-block presented in connection with FIG. 8, the splitting of the current sub-block SB carried out in c′31 implements the principle of the invention, that is to say it implements the steps a), b) of the coding method according to the invention. In a) a motion estimation is performed with respect to the reference image IR, a basic motion vector MVb′ is obtained, in b) the partitioning of the prediction block pointed to by the motion vector MVb′ is obtained and then applied to the current sub-block SB.

We understand that this is a recursive implementation of the invention.

Different ways of reporting the splitting of a sub-block are possible: given a predetermined scanning order of the sub-blocks of the partitioning, the following may be mentioned by way of example:
marking for each sub-block of a partition, a score 0 or 1 to indicate whether the current sub-block is split for example in a “quadtree” mode and for each of the sub-blocks obtained, if it has split again;
if the sub-block has been split again, marketing the way the new partitioning is obtained, according to the splitting method adopted. For example, if the partitioning is split using a “quadtree”-type method as is the case according to the HEVC standard, the associated reporting follows the HEVC recommendation and in particular the section 7.3.8.4 entitled “Coding quadtree syntax”.

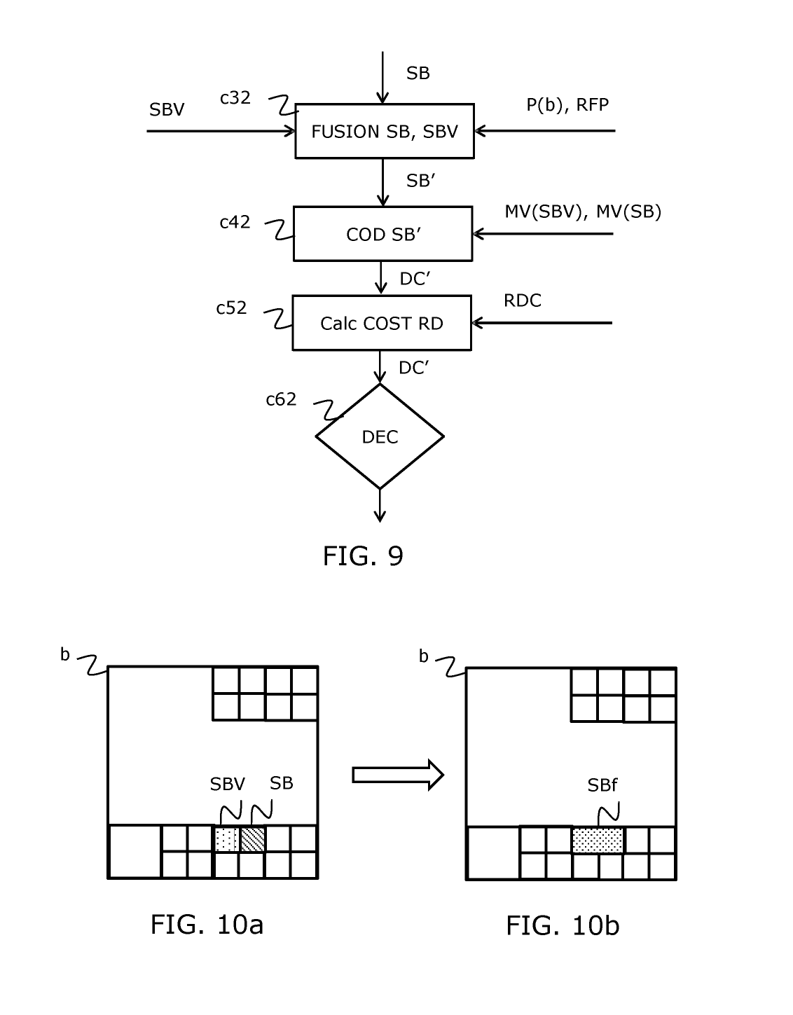

In relation to FIG. 9, we now describe the sub-steps of changing and coding the partitioning of the current block b, where a merger of the current sub-block with a neighbouring sub-block already coded is implemented.

The sub-blocks of the current block are coded according to a predetermined scanning order.

In connection with FIG. 10a, we consider a sub-block SB which has just been coded. The step c32 carries out a merger of the sub-block SB with a previously coded neighbour SBV according to the scanning order. FIG. 10b shows the enlarged sub-block obtained SBf. This enlarged sub-block SBf is encoded c42. During this step, the prediction of the sub-block SBf merged can be implemented according to a prediction mode of Inter, Merge or Intra type, as described above. In the case of Inter mode, a motion vector MVf is assigned to the enlarged sub-block, either by implementing a new motion estimation step that provides a new motion vector which will have to be transmitted to the decoder, or by reusing one of the motion vectors of one of the two sub-blocks merged. In this case the motion vector reused can be marked with an index in the bitstream.

Different ways to report the merger are possible: given a predetermined scanning order of the sub-blocks of the partitioning, the following may be mentioned by way of example:
marking for each sub-block of a partitioning a score 0 or a 1 to indicate whether the current sub-block is merged with a neighbouring sub-block according to the scanning order; or
marking only the number of the current sub-block, followed by the distance (in the scanning order) to the neighbouring sub-block with which it merges (e.g.: 0 for the first neighbour in the scanning order).

Upon completion of the coding step, the cost RD of the merger is calculated in c52. Advantageously, this calculation takes into account the coding cost of the residue of the enlarged sub-block, the coding cost of its motion vector MVf and the cost of reporting the merger of the two neighbouring sub-blocks.

The total cost calculated is compared in c52 to the sum of the costs of the two sub-blocks SB and SBV coded separately and a decision to adopt the merger is made in c62, if this total cost is less than the sum of the costs of coding separate sub-blocks. Otherwise, the merger is not retained.

Then the encoder can test the merger of the current sub-block with another neighbouring sub-block already coded.

It is understood that to merge enables to save a motion vector, but makes the prediction less fine and reporting the partitioning more expensive. The merger is a choice of the encoder. For example, the encoder can always try the merger of a sub-block of a partitioning with all its neighbouring sub-blocks and keep only the sound mergers, that is to say those that contribute to reduce generally to reduce the coding cost.

The bitstream TB produced by the method of encoding according to the invention which has just been described is unique in that it comprises, for the coding of a current block, marking information relative to:
choosing for the current block, the coding mode according to the invention, namely the fact of applying the partitioning of the prediction block to the current block;
the possible modification of the initial partitioning, by splitting or merging; for example, a binary sequence may indicate that the initial partitioning (1) has been modified, or not (0). In case of modification, a binary sequence can indicate whether it is a splitting (0) or a merger (1). In both cases, a binary sequence then describes the splitting and the merger. For example, the splitting is marked by a binary sequence in agreement with the splitting method adopted. For example, if the partitioning is split using a “quadtree” HEVC-type method, the marking of the associated “quadtree” follows the HEVC recommendation and in particular the section 7.3.8.4 entitled “Coding quadtree syntax”. A merger is marked by a binary sequence which describes whether the current block merges (1) or not (0) with its neighbour, in a predefined order. The set of these binary sequences can be coded using an entropy coder of the Huffman type or of the arithmetic type using specific contexts in order to reduce the marking cost associated;
The possible re-use of the estimated motion vector for the current sub-block or the neighbouring sub-block during a modification of the initial partitioning.

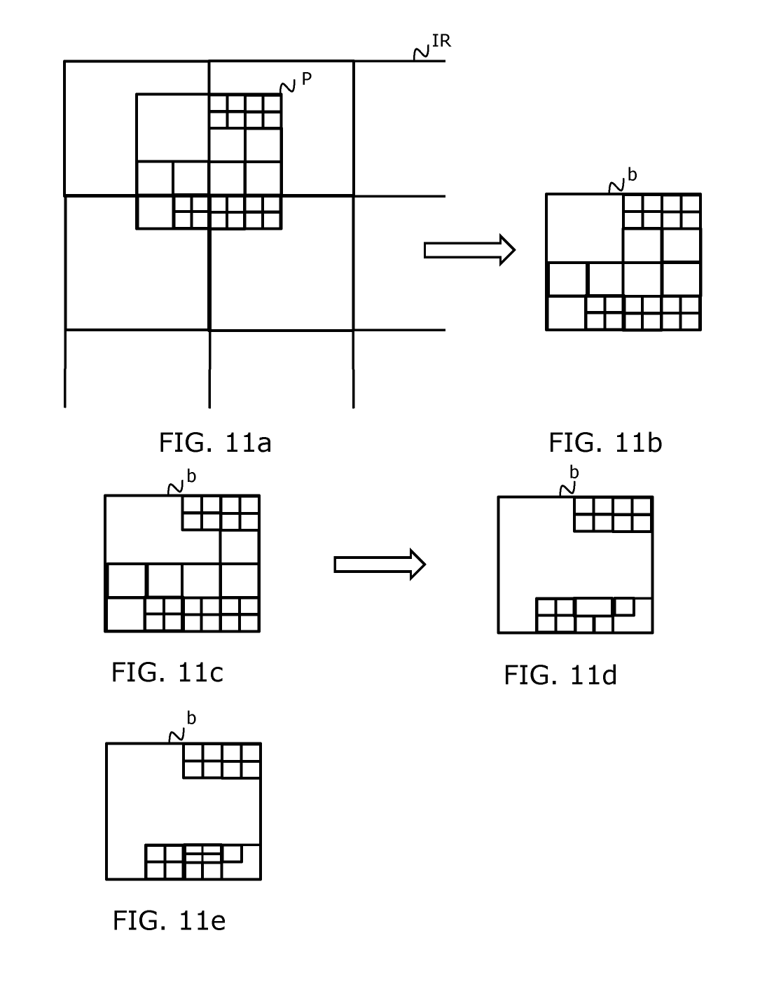

In connection with FIGS. 11a to 11e, we present an embodiment of the invention wherein the initial partitioning of a current block b is changed repeatedly, some sub-blocks being merged, others being divided. FIG. 11a illustrates that the partitioning corresponding to the prediction block is not necessarily regular, in that it corresponds to partitioning pieces of several blocks of the reference image. FIGS. 11b, 11e and 11d show successive mergers. FIG. 11e illustrates an example of splitting a sub-block. Note that in this example, the number of motion vectors to be transmitted is 21 for a total number of 28 according to the HEVC standard. Of course, if too many mergers are implemented, marking cost increases. It is thus the coder which experiences the coding cost of changes made to the original partitioning and achieves the best rate-distortion compromise.

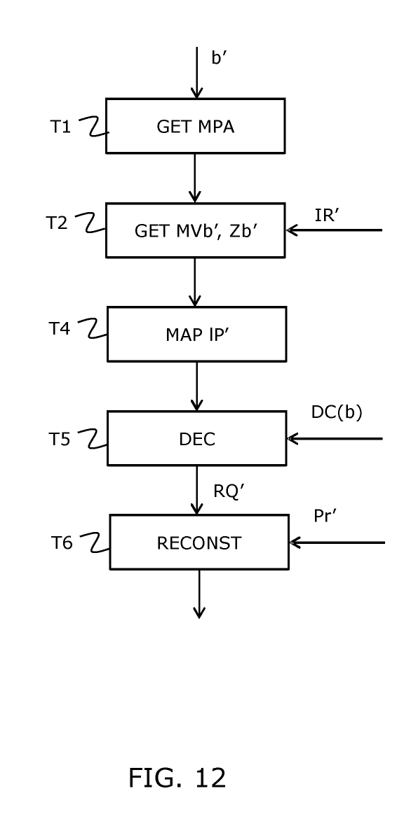

The bitstream TB produced by the method of encoding according to the invention is transmitted to a decoder. This decoder implements a method of decoding according to the invention will now be described in connection with FIG. 12.

It is assumed that the decoder reads and analyses in a known manner the coded data DC received in the bitstream. We particularly consider the coded data for a current block of a digital image Im.

According to the invention, the decoder extracts in T1 a piece of marking information on the partitioning scheme MPA implemented to code the current block b′. This is a classic example of partitioning, of “Quadtree” type, or of the partitioning mode according to the invention.

In the case where the partitioning mode MPA used for the current block is that of the invention, the decoder obtains in T2 the basic motion vector MVb′ to be used in determining the prediction block Pr′ of the current block in the reference image IR′. According to the embodiment implemented, it can get either a piece of marking information indicating that the motion vector MVb′ is deduced from that of a neighbouring block already coded or data representative of the actual motion vector.

Once the motion vector MVb′ has been obtained, the decoder implements a step T3 for obtaining an initial partitioning lPi of the current block. This partitioning is that of the prediction block Pr′, that is to say the area Zb′ pointed to by the motion vector MVb′ in the reference image IR already decoded. The decoder therefore computes the coordinates of the area in the reference image and searches the memory for the partitioning of the various blocks of the reference image that contribute to this area.

In T4, it applies this partitioning to the current block. This is its initial partitioning. It then begins in T5 to scan the sub-blocks defined by this initial partitioning according to a predetermined scanning order that it shares with the coder. For example, this scanning order is determined beforehand.

For a current sub-block SB′, it extracts from the bitstream any marking information relating to a modification of the initial partitioning of the block at this sub-block SB′. If it does not extract any information, the sub-block has not been changed. In this case, it decodes it from the coded data received in the bitstream.

Alternatively, it extracts in T5 marking information relating to a modification of the partitioning at the current sub-block.

For example, these pieces of information first comprise a piece of information representing a type of change applied to the initial partitioning, splitting or merging, followed by information representative of a difference between the modified partitioning and the initial partitioning.

In a first case, the current sub-block is split. As previously mentioned, this split can rely on a conventional “Quadtree”-type partitioning or on the partitioning mode of the invention.

If it is a classic partitioning mode, the decoder extracts from the bitstream marking information related to this partitioning and to the prediction mode used for each of the sub-blocks obtained. It decodes conventionally the sub-blocks obtained.

In the case of the partitioning mode according to the invention, the decoder repeats the steps already described, i.e. of extracting from the bitstream marking information relating to the motion vector (re-used or coded) and obtaining the motion vector, of obtaining the partitioning of the sub-block for predicting the reference image, of applying this partitioning to the current sub-block and of decoding the sub-blocks from the re-split current sub-block.

According to a second case, the modification to the initial partitioning is a merger of the current sub-block with a neighbouring sub-block already decoded. The decoder extracts from the bitstream marking information for identifying the neighbouring sub-block and updates the partitioning of the block b′ by replacing the sub-blocks merged by the enlarged sub-block. It will be noted that it may be more than two neighbouring sub-blocks merged into one enlarged sub-block.

It then reads in the bitstream the prediction mode implemented for the enlarged sub-block. In the case of an Inter prediction mode, it obtains the basic movement vector to be applied to the enlarged sub-block to compensate it in motion with respect to the reference image. Then it decodes the enlarged sub-block from the coded data extracted from the bitstream.

Once all residue of the sub-blocks of the current block b′ have been decoded, the decoding method reconstructs in T6 the quantised residual RQ′ of the block b′ and dequantises it. This last operation is carried out by means appropriate to the quantisation used during coding, for example a scalar or vector dequantisation . . . ). Then, it applies an inverse transformation of the dequantised current block and reconstructed the decoded block b′ by adding the residue to the prediction Pr′ of the current block b′.

The reconstructed block b′ is integrated with the image being decoded.

Note that the invention which has just been described, can be implemented using software and/or hardware components. In this context, the terms “module” and “entity” used in this document, can correspond either to a software component or a hardware component or even a set of hardware and/or software components, capable to implement the function(s) outlined for the module or entity concerned.

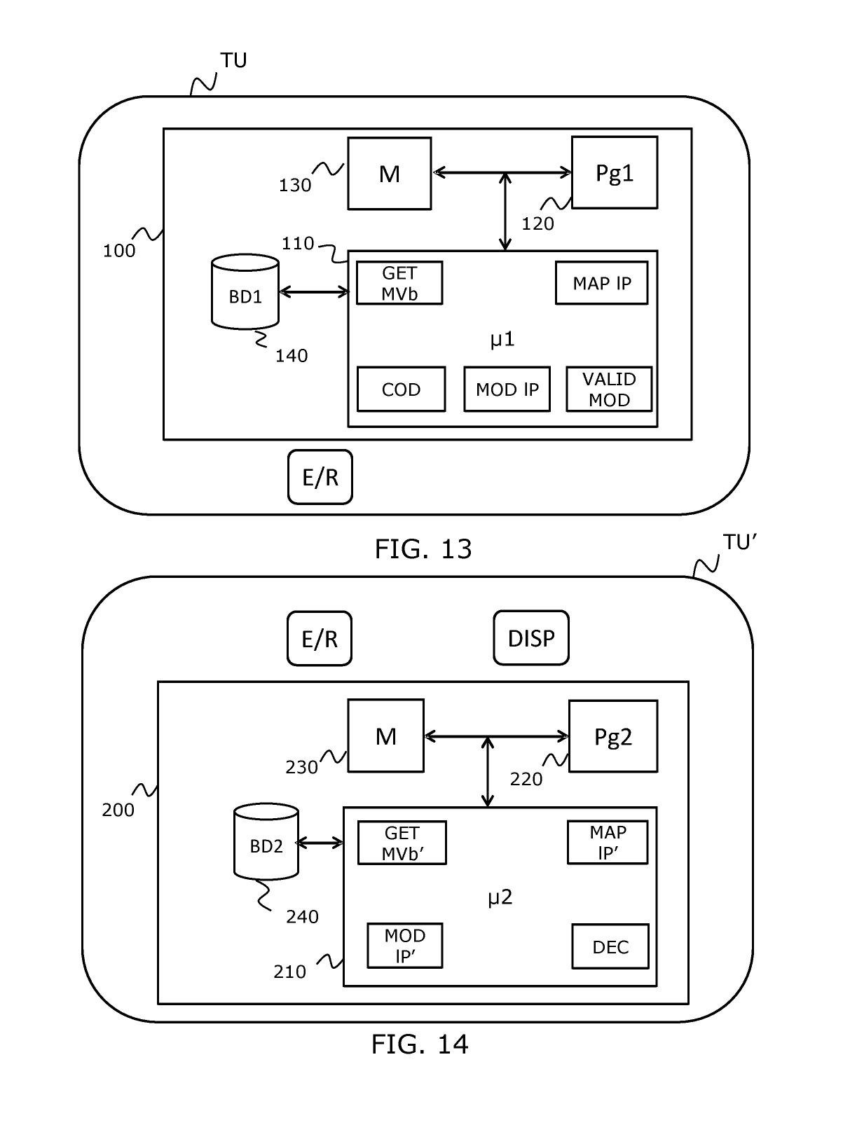

FIG. 13 now shows schematically an example of a simplified structure of a device 100 for coding a digital image according to the invention. The device 100 implements the coding method according to the invention which has just been described in relation to FIGS. 4 to 9.

For example, the device 100 includes a processing unit 110, equipped with a processor μ1 and driven by a computer program Pg₁ 120, stored in a memory 130 and implementing the coding process according to the invention.

At initialisation, the code instructions of the computer program Pg₁ 120 are for example loaded into a RAM memory before being executed by the processor of the processing unit 110. The processor of the processing unit 110 implements the steps of the method described above, according to the instructions of the computer program 120.

In this embodiment of the invention, the device 100 comprises at least one unit GET MVb for obtaining a basic motion vector for the current block with respect to a reference image, a unit GET PART for obtaining a partitioning of the prediction block PU pointed to by the basic vector motion estimated, a unit MAP PART for applying the partitioning obtained applying to the current block and a unit COD coding sub-blocks of the current block defined by the applied partitioning.

Advantageously, the device 100 further comprises a unit MOD 1P for modifying the partitioning obtained for the block (b′) and a unit VALID MOD for validating the modification.

These units are driven by the processor μ1 of the processing unit 110.

Advantageously, such a device 100 can be integrated into a user terminal TU. The device 100 is then arranged to engage at least one module E/R for transmitting/receiving data from the user terminal, via which the bitstream TB or the compressed file FC is transmitted in a telecommunications network, for example a wired network or a wireless network.

FIG. 14 now shows schematically an example of a simplified structure of a device 200 for decoding a digital image according to the invention. The device 200 implements the method of decoding according to the invention which has just been described in relation to FIG. 11.

For example, the device 200 includes a processing unit 210, equipped with a processor μ2 and driven by a computer program Pg₂ 220, stored in a memory 230 and implementing the decoding process according to the invention.

At initialisation, the code instructions of the computer program Pg₂ 220 are for example loaded into a RAM memory before being executed by the processor of the processing unit 210. The processor of the processing unit 210 implements the steps of the method described above, according to the instructions of the computer program 220.

In this embodiment of the invention, the device 200 comprises at least one unit GET MVb′ for obtaining a basic motion vector MVb′ between the current block and a previously decoded reference image, a unit GET PART for obtaining a partitioning of the pointed area in the reference image (b′), a unit MAP PART of applying the partitioning obtained in the current block (b) and a unit DEC for scanning the sub-blocks of the current block (b) according to a predetermined scanning order and for decoding the coded data read in the bit stream for the sub-blocks scanned.

Advantageously, the device 200 further comprises a unit MOD 1P of modifying the partitioning obtained for the block (b′) from coded data read in the bitstream TB.

These units are driven by the processor μ2 of the processing unit 210.

Advantageously, such a device 200 can be integrated into a user terminal TU′. The device 200 is then arranged to cooperate with at least the following module of the terminal TU:
A module E/R for transmitting/receiving data, via which the bitstream TB or the compressed folder FC is received from a telecommunications network;
A device DISP for restoring images, for example a terminal screen, via which the decoded digital image or the sequence of decoded images is restored to a user.

Advantageously, a user terminal TU, TU′ can include both a device for encoding and a device for decoding according to the invention.

An exemplary embodiment of the invention improves the situation discussed above with respect to the prior art.

An exemplary embodiment of the invention overcomes these shortcomings of the prior art.

More precisely, an exemplary embodiment proposes a solution that makes it possible to predict and more efficiently encode complex image structures.

An exemplary embodiment of the invention offers a solution that is more efficient in compression.

It goes without saying that the embodiments which have been described above have been given purely by an indicative and non-limiting way, and that many modifications can be easily made by those skilled in the art without departing from the scope of the invention.

1. A method for encoding a digital image, said image being divided into a plurality of blocks of pixels processed in a defined order, said method comprising the following acts, implemented by an encoding device:
implementing the following acts for a current block:
a) obtaining a basic motion vector of the current block with respect to a reference image previously decoded;
b) obtaining a partitioning into sub-blocks of an area pointed to in the reference image by the basic motion vector and applying the partitioning to the current block;
c) scanning the sub-blocks of the current block according to a predetermined scanning order and encoding the sub-blocks scanned, wherein said encoding comprises:
modifying the partitioning of the current block into sub-blocks according to predetermined rules,
coding the sub-blocks of the modified partitioning comprising coding reporting information for changing the partitioning, and
validating the modified partitioning by applying a rate-distortion criterion to the coded sub-blocks of the modified partitioning; and
performing at least one of transmitting the coded sub-blocks via a communication network or storing the coded sub-blocks in a non-transitory computer-readable medium.

2. The method for encoding a digital image according to claim 1, obtaining the basic motion vector comprises estimating the motion of the current block with respect to the reference image previously decoded according to an error minimisation criterion.

3. The method for encoding a digital image according to claim 1, wherein modifying comprises merging a sub-block of the coded current partitioning with at least one neighbouring sub-block already coded.

4. The method for encoding a digital image according to claim 1, wherein modifying the current partitioning further comprises splitting at least one sub-block into at least two sub-blocks.

5. The method for encoding a digital image according to claim 4, wherein splitting said at least one sub-block into at least two sub-blocks, so-called split sub-blocks, comprises implementing the acts a) and b) for said at least one current sub-block.

6. A device for encoding a digital image, said image being divided into a plurality of blocks of pixels processed in a defined order, said device comprising:
a non-transitory computer-readable medium comprising instructions stored thereon;
a processor configured by the instructions to perform the following acts:
implementing the following acts for a current block:
obtaining a basic motion vector of the current block with respect to a reference image previously decoded;
obtaining a partitioning into sub-blocks of an area pointed to in the reference image by the basic motion vector and applying the partitioning to the current block; and
scanning the sub-blocks of the current block according to a predetermined scanning order and encoding the sub-blocks scanned, wherein said encoding includes:
modifying the partitioning of the current block into sub-blocks according to predetermined rules,
coding the sub-blocks of the modified partitioning comprising coding reporting information for changing the partitioning, and
validating the modified partitioning by applying a rate-distortion criterion to the coded sub-blocks of the modified partitioning; and
performing at least one of transmitting the coded sub-blocks via a communication network or storing the coded sub-blocks in a non-transitory computer-readable medium.

7. A method for decoding a digital image from a bitstream comprising coded data representative of said image, said image being divided into a plurality of blocks processed in a defined order, said method comprising the following acts performed by a decoding device:
receiving the bitstream comprising coded data via a communication network; and
performing the following acts, implemented for a current block:
a′) obtaining a basic motion vector of the current block and a reference image previously decoded, said motion vector pointing to an area of the reference image, of the same size as that of the current block;
b′) obtaining a partitioning into sub-blocks of the area pointed to in the reference image by the basic motion vector and application to the current block;
c′) scanning the sub-blocks of the current block according to a predetermined scanning order and decoding the coded data read in the bitstream for the sub-blocks scanned, said decoding comprising:
modifying the partitioning, obtained for the current block according to coded data representative of reporting of the modification of the partitioning, and
decoding the partitioning as modified.

8. The method for decoding a digital image from a bitstream comprising coded data representative of said image according to claim 7, wherein, when the coded data report a merger, the act of modifying the initial partitioning replaces said at least two neighbouring sub-blocks of the initial partitioning with a sub-block in the modified partitioning and the act of decoding comprises decoding the sub-block.

9. The method for decoding a digital image from a bitstream comprising coded data representative of said image according to claim 7, wherein, when the coded data report splitting a sub-block of the current partitioning into at least two sub-blocks, the step of modifying the partitioning applies the splitting reported at the current sub-block and the decoding step decodes the sub-blocks obtained according to a predetermined scanning order.

10. The method for decoding a digital image from a bitstream comprising coded according to claim 9, wherein the act of splitting the sub-block into at least two sub-blocks implements the steps a′), b′), c′) for the current sub-block.

11. A device for decoding a digital image from a bitstream comprising coded data representative of said image, said image being divided into a plurality of blocks processed in a defined order, said device comprising:
a non-transitory computer-readable medium comprising instructions stored thereon;
a processor configured by the instructions to perform the following acts:
receiving the bitstream comprising coded data via a communication network; and
performing the following acts for a current block:
obtaining a basic motion vector of the current block and a reference image previously decoded, said motion vector pointing to an area of the reference image, of the same size as that of the current block;
obtaining a partitioning into sub-blocks of the area pointed to in the reference image by the basic motion vector and application to the current block;
scanning the sub-blocks of the current block according to a predetermined scanning order and decoding the coded data read in the bitstream for the sub-blocks scanned, wherein said decoding comprises:
modifying the partitioning, obtained for the current block according to coded data representative of reporting of the modification of the partitioning, and
decoding the partitioning as modified.

12. (canceled)

13. A user terminal comprising:
at least one non-transitory computer-readable medium comprising instructions stored thereon;
at least one processor configured by the instructions to perform the following acts:
encoding a digital image, said image being divided into a plurality of blocks of pixels processed in a defined order, said encoding comprising:
a) implementing the following acts for a current block:
obtaining a basic motion vector of the current block with respect to a reference image previously decoded;
obtaining a partitioning into sub-blocks of an area pointed to in the reference image by the basic motion vector and applying the partitioning to the current block; and
scanning the sub-blocks of the current block according to a predetermined scanning order and encoding the sub-blocks scanned, wherein said encoding includes:
modifying the partitioning of the current block into sub-blocks according to predetermined rules,
coding the sub-blocks of the modified partitioning comprising coding reporting information for changing the partitioning, and
validating the modified partitioning by applying a rate-distortion criterion to the coded sub-blocks of the modified partitioning; and
b) performing at least one of transmitting the coded sub-blocks via a communication network or storing the coded sub-blocks in a non-transitory computer-readable medium; and
decoding a digital image from a bitstream comprising coded data representative of said image, said image being divided into a plurality of blocks processed in a defined order, said decoding comprising:
a) receiving the bitstream comprising coded data via a communication network; and
b) performing the following acts for a current block:
obtaining a basic motion vector of the current block and a reference image previously decoded, said motion vector pointing to an area of the reference image, of the same size as that of the current block;
obtaining a partitioning into sub-blocks of the area pointed to in the reference image by the basic motion vector and application to the current block; and
scanning the sub-blocks of the current block according to a predetermined scanning order and decoding the coded data read in the bitstream for the sub-blocks scanned, wherein said decoding comprises:
modifying the partitioning, obtained for the current block according to coded data representative of reporting of the modification of the partitioning, and
decoding the partitioning as modified.

14. A non-transitory computer-readable medium comprising a computer program stored thereon and comprising instructions for encoding a digital image, when executed by a processor of an encoding device, said image being divided into a plurality of blocks of pixels processed in a defined order, wherein the instructions configure the encoding device to perform the following acts:
performing the following acts for a current block:
a) obtaining a basic motion vector of the current block with respect to a reference image previously decoded;
b) obtaining a partitioning into sub-blocks of an area pointed to in the reference image by the basic motion vector and applying the partitioning to the current block; and
c) scanning the sub-blocks of the current block according to a predetermined scanning order and encoding the sub-blocks scanned, wherein said encoding comprises:
modifying the partitioning of the current block into sub-blocks according to predetermined rules,
coding the sub-blocks of the modified partitioning comprising coding reporting information for changing the partitioning, and
validating the modified partitioning by applying a rate-distortion criterion to the coded sub-blocks of the modified partitioning; and
performing at least one of transmitting the coded sub-blocks via a communication network or storing the coded sub-blocks in a non-transitory computer-readable medium.

15. A non-transitory computer-readable medium comprising a computer program stored thereon and comprising instructions for decoding a digital image from a bitstream, when executed by a processor, wherein the bitstream comprises coded data representative of said image, said image being divided into a plurality of blocks processed in a defined order, wherein the instructions configure the decoding device to perform the following acts:
receiving the bitstream comprising coded data via a communication network; and
performing the following acts, implemented for a current block:
a′) obtaining a basic motion vector of the current block and a reference image previously decoded, said motion vector pointing to an area of the reference image, of the same size as that of the current block;
b′) obtaining a partitioning into sub-blocks of the area pointed to in the reference image by the basic motion vector and application to the current block;
c′) scanning the sub-blocks of the current block according to a predetermined scanning order and decoding the coded data read in the bitstream for the sub-blocks scanned, said decoding comprising:
modifying the partitioning, obtained for the current block according to coded data representative of reporting of the modification of the partitioning, and
decoding the partitioning as modified.
